(19) United States
(12) Patent Application Publication
(10) Pub. No.: US 2026/0105075 A1
(43) Pub. Date: Apr. 16, 2026

(54) MONITORING USER ACTIVITY WITHIN GEOFENCED ENVIRONMENTS

(71) Applicant: Weavix, Inc., Wichita, KS (US)

(72) Inventors: Kevin TURPIN, Wichita, KS (US); Benjamin BURRUS, Wichita, KS (US)

(21) Appl. No.: 18/917,608

(22) Filed: Oct. 16, 2024

(51) Int. Cl. G06F 16/29; G06Q 10/0633

(52) U.S. Cl. CPC G06F 16/29; G06Q 10/0633

(57) ABSTRACT

A device monitors the steps and movement of the user within a worksite to measure the user’s experience associated with the worksite and generate a resume based on the user’s experience. The device obtains a set of geospatial data that indicates the content of a geographic area bounded within a geofence. Sensors of the device detects a presence of a user within the geofence. The user is associated with a user profile, and the user profile indicates the frequency and/or magnitude of the user's presence at the content of the geographic area. The sensors of the device calculates the number of steps traveled by the user within the geofence. The device modifies the user profile to increase the frequency or magnitude of the user's presence at the content of the geographic area indicated by the user profile in accordance with the number of steps.

### TECHNICAL FIELD

The present disclosure is generally related to wireless communication handsets and systems.

### BACKGROUND

A pedometer, or step-counter, is a device, usually portable and electronic or electromechanical, that counts each step a person takes by detecting the motion of the person's hands or hips. Typically worn on the person, pedometers use sensors such as accelerometers to measure the movement associated with walking or running. The primary function of a pedometer is to enable monitoring of the person’s physical activity levels.

The absence of pedometer functionality in traditional radios means that while traditional radios enable limited communication services, traditional radios do not offer insights into the activity levels of workers and thus require workers to carry additional devices to stay adequately connected to their team. Often, these devices are unfit for in-field use due to their fragile design or their lack of usability during frontline work. For example, smartphones, laptops, or tablets with additional communication capabilities may be easily damaged in the field, difficult to use in a dirty environment or when wearing protective equipment, or overly bulky for daily transportation on site. Accordingly, workers may be less accessible to their teams, which can lead to safety concerns and a decrease in productivity.

### BRIEF DESCRIPTION OF THE DRAWINGS

FIG. 1 is a block diagram illustrating an example architecture for an apparatus for device communication and tracking, in accordance with one or more embodiments.

FIG. 2 is a block diagram illustrating an example apparatus for device communication and tracking, in accordance with one or more embodiments.

FIG. 3 is a block diagram illustrating an example charging station for apparatuses implementing device communication and tracking, in accordance with one or more embodiments.

FIG. 4A is a block diagram illustrating an example environment for apparatuses and communication networks for device communication and tracking, in accordance with one or more embodiments.

FIG. 4B is a flow diagram illustrating an example process for generating a work experience profile, in accordance with one or more embodiments.

FIG. 5 is a block diagram illustrating an example facility using apparatuses and communication networks for device communication and tracking, in accordance with one or more embodiments.

FIG. 6 illustrates an example of a worksite that includes a plurality of geofenced areas, in accordance with one or more embodiments.

FIG. 7 is a block diagram illustrating an example architecture for generating a user profile based on user activity within a geofenced environment, in accordance with one or more embodiments.

FIG. 8 is a block diagram illustrating an example environment for monitoring user activity within a geofenced environment, in accordance with one or more embodiments.

FIG. 9 is a block diagram illustrating a generated user profile displaying the monitored user activity, in accordance with one or more embodiments.

FIG. 10 is a flow diagram illustrating a process or method for monitoring user activity within a geofenced environment, in accordance with one or more embodiments.

FIG. 11 is a block diagram illustrating an example computer system, in accordance with one or more embodiments.

### DETAILED DESCRIPTION

Tracking user activity levels (e.g., steps) in worksites is used not only to monitor worker safety but also to assess user productivity and/or construct resumes of the user (e.g., a worker within the worksite). Monitoring physical activity enables supervisors to ensure that workers are adhering to safety protocols, particularly in hazardous environments where excessive or insufficient movement indicate potential risks. For example, tracking user activity can reveal if a worker is spending too much time in high-risk areas or if they are not moving enough, which could signal fatigue or health issues. Further, tracking user activity levels offers quantifiable measures of a worker's engagement and efficiency and thus provides objective data for assessing performance and identifying top performers, which is particularly important in industries where physical activity and presence in specific areas are key indicators of expertise and proficiency. For example, a worker frequently operating in high-risk zones or completing a significant number of steps in a manufacturing plant demonstrates a high level of experience and reliability. The quantified measures derived from the monitored worker activity (e.g., steps, movement) can be subsequently used to generate resumes that approximate reflect a worker’s experience within the worksite.

However, conventional approaches for tracking user activity in worksites often struggle when relying on traditional radios. Traditional radios are primarily designed for voice communication and lack sensors, such as accelerometers and GPS modules, used for capturing physical activity data. Thus, conventional approaches rely on manual reporting to track user activity. Manual reporting is inherently prone to human error, as workers may forget to log their activities accurately or may not have the time to do so amidst their tasks. This can lead to incomplete or inaccurate data related to information such as the location, duration, and intensity of activities. Additionally, manual reporting is time-consuming and inefficient, requiring workers to take time away from their primary work responsibilities to record their actions. This not only reduces productivity but also increases the administrative burden on both workers and supervisors who verify and compile the reported data. Without accurate user activity information, managers cannot accurately gauge task efficiency or make informed decisions about workload distribution, worker performance, and time management.

Disclosed herein are systems, methods, and computer-readable media for managing user activity in a geofenced environment. The system tracks and analyzes user activity within a defined geographic area using geospatial data. A device (e.g., a mobile radio device) obtains a set of geospatial data that defines a geofence. The geofence outlines a virtual perimeter around the geographic area and indicates the content (e.g., type of worksite) within this boundary. The device's sensors detect the presence of a user within the geofence, associating the user with a profile that records the frequency or magnitude of their presence in the area. The sensors determine the distance the user travels within the geofence by monitoring changes in location or speed and calculate the number of steps taken. The computing device updates the user profile to reflect the increased frequency or magnitude of the user's presence in the area, based on the number of steps traveled. The device generates a resume for the user, incorporating the updated frequency or magnitude of presence and detailing the content of the geographic area.

By managing user activity through geospatial data within the radio, the system reduces the inaccuracies and inefficiencies associated with manual reporting. Activity data on worker activity is accurate and available in real-time, enabling managers to make informed decisions about workload distribution, task efficiency, and worker performance. By generating resumes that reflect a worker's activity levels and experience, the system also aids in career development and training needs assessment. For instance, a resume reflects objective evidence of a worker's physical activity, such as the number of steps taken and the distance traveled, which can be particularly useful to demonstrate a worker's efficiency and/or experience to potential new or existing employers.

Mobile radio devices (e.g., smart radios, safety user devices) can be used to communicate between various workers. As the responsibilities of these workers adapt with technology, however, the functionality of mobile radio devices must evolve to provide additional functionality. For example, mobile radio devices have been improved to increase connectivity in previously disconnected locations. Moreover, improvements in mobile radio devices enable workers to communicate through additional forms of communication, often without user intervention. Mobile radio devices also provide a mechanism for tracking workers and equipment on a worksite to improve safety and efficiency. Mobile radio devices can further track details about employees during their work shift, and that information can be used to analyze the employees’ strengths and weaknesses. Accordingly, the present disclosure relates to improvements in mobile radio devices. In general, improvements are directed to one of four technical aspects (“pillars”): network connectivity, collaboration, location services, and data, which are explained below.

Network connectivity: Smart radios operate using multiple onboard radios and connect to a set of known networks. This pillar refers to radio selection (e.g., use of multiple onboard radios in various contexts) and network selection (e.g., selecting which network to connect to from available networks in various contexts). These decisions may depend on data obtained from other pillars; however, inventions directed to the connectivity pillar have outputs that relate to improvements to network or radio communications/selections.

Collaboration: This pillar relates to communication between users. A collaboration platform includes chat channel selection, audio transcription and interpretation, sentiment analysis, and workflow improvements. The associated smart radio devices further include interface features that improve ease of communication through reduction in button presses and hands-free information delivery. Inventions in this pillar relate to improvements or gained efficiencies in communicating between users and/or the platform itself.

Location services: This pillar refers to various means of identifying the location of devices and people. There are straightforward or primary means, such as the Global Positioning System (GPS), accelerometer, or cellular triangulation. However, there are also secondary means by which known locations (via primary means) are used to derive the location of other unknown devices. For example, a set of smart radio devices with known locations are used to triangulate other devices or equipment. Further location services inventions relate to identification of the behavior of human users of the devices, e.g., micromotions of the device indicate that it is being worn, whereas lack of motion indicates that the device has been placed on a surface. Inventions in this pillar relate to the identification of the physical location of objects or workers.

Data: This pillar relates to the “Internet of Workers” platform. Each of the other pillars leads to the collection of data. Implementation of that data into models provides valuable insights that illustrate a given worksite to users who are not physically present at that worksite. Such insights include productivity of workers, experience of workers, and accident or hazard mapping. Inventions in the data pillar relate to deriving insight or conclusions from one or more sources of data collected from any available sensor in the worksite.

Embodiments of the present disclosure will now be described with reference to the following figures. Although illustrated and described with respect to specific examples, embodiments of the present disclosure can be embodied in many different forms and should not be construed as limited to the embodiments set forth herein. Accordingly, the examples set forth herein are non-limiting examples referenced to improve the description of the present technology.

### Portable Wireless Apparatus

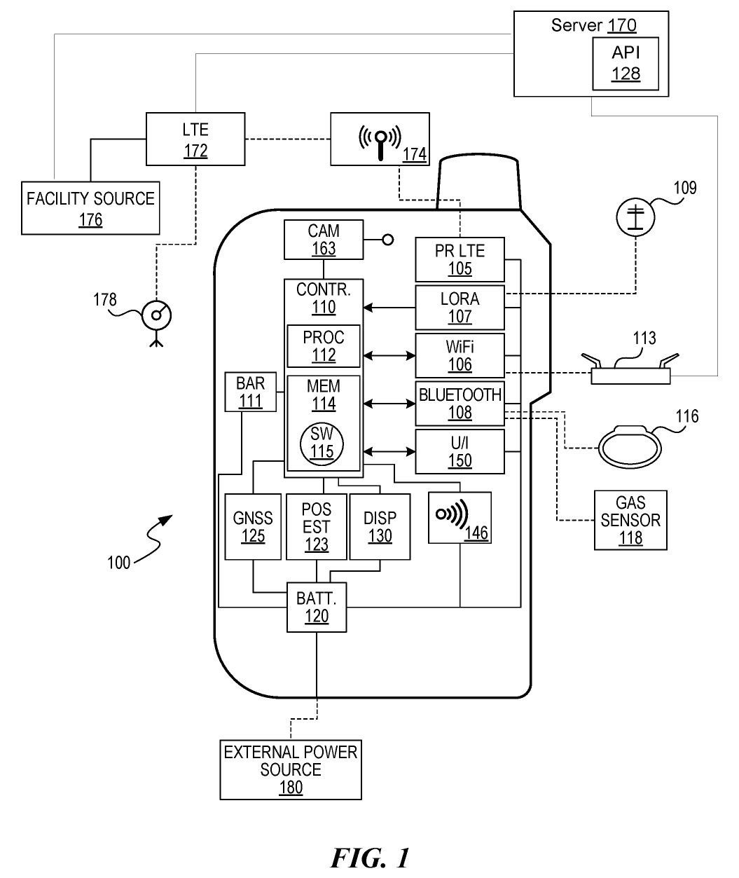

FIG. 1 is a block diagram illustrating an example architecture for an apparatus 100 for device communication and tracking, in accordance with one or more embodiments. The wireless apparatus 100 is implemented using components of the example computer system illustrated and described in more detail with reference to subsequent figures. In embodiments, the apparatus 100 is used to execute the ML system illustrated and described in more detail with reference to subsequent figures. The architecture shown by FIG. 1 is incorporated into a portable wireless apparatus 100, such as a smart radio, a smart camera, a smart watch, a smart headset, or a smart sensor. Although illustrated in a particular configuration, different embodiments of the apparatus 100 include different and/or additional components connected in different ways.

The apparatus 100 includes a controller 110 communicatively coupled either directly or indirectly to a variety of wireless communication arrangements. The apparatus 100 includes a position estimating component 123 (e.g., a dead-reckoning system), which estimates current position using inertia, speed, and intermittent known positions received from a position tracking component 125, which, in embodiments, is a Global Navigation Satellite System (GNSS) component. A battery 120 is electrically coupled with a cellular subsystem 105 (e.g., a private Long-Term Evolution (LTE) wireless communication subsystem), a Wi-Fi subsystem 106, a low-power wide area network (LPWAN) (e.g., LPWAN/long-range (LoRa) network subsystem 107), a Bluetooth subsystem 108, a barometer 111, an audio device 146, a user interface 150, and a built-in camera 163 for providing electrical power.

The battery 120 can be electrically and communicatively coupled with the controller 110 for providing electrical power to the controller 110 and to enable the controller 110 to determine a status of the battery 120 (e.g., a state of charge). In embodiments, the battery 120 is a non-removable rechargeable battery (e.g., using external power source 180). In this way, the battery 120 cannot be removed by a worker to power down the apparatus 100, or subsystems of the apparatus 100 (e.g., the position tracking component 125), thereby ensuring connectivity to the workforce throughout their shift. Moreover, the apparatus 100 cannot be disconnected from the network by removing the battery 120, thereby reducing the likelihood of device theft. In some cases, the apparatus 100 can include an additional, removable battery to enable the apparatus 100 to be used for prolonged periods without requiring additional charging time.

The controller 110 is, for example, a computer having a memory 114, including a non-transitory storage medium for storing software 115, and a processor 112 for executing instructions of the software 115. In some embodiments, the controller 110 is a microcontroller, a microprocessor, an integrated circuit (IC), or a system-on-a-chip (SoC). The controller 110 can include at least one clock capable of providing time stamps or displaying time via display 130. The at least one clock can be updatable (e.g., via the user interface 150, the position tracking component 125, the Wi-Fi subsystem 106, the private cellular network 107 subsystem, a server, or a combination thereof).

The wireless communications arrangement can include a cellular subsystem 105, a Wi-Fi subsystem 106, a LPWAN/LoRa network subsystem 107 wirelessly connected to a LPWAN network 109, or a Bluetooth subsystem 108 enabling sending and receiving. Cellular subsystem 105, in embodiments, enables the apparatus 100 to communicate with at least one wireless antenna 174 located at a facility (e.g., a manufacturing facility, a refinery, or a construction site), examples of which may be illustrated in and described with respect to the subsequent figures.

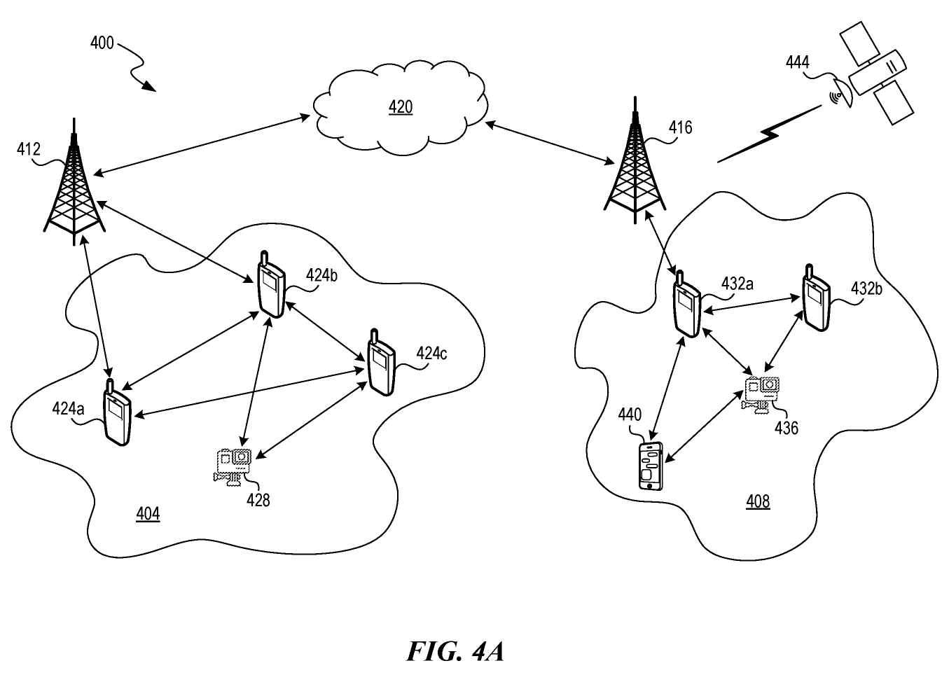

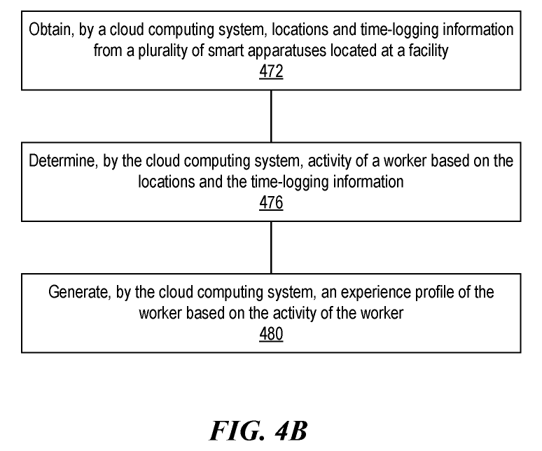

In embodiments, a cellular edge router arrangement 172 is provided for implementing a common wireless source. The cellular edge router arrangement 172 (sometimes referred to as an “edge kit”) can provide a wireless connection to the Internet. In embodiments, the LPWAN network 109, the wireless cellular network, or a local radio network is implemented as a local network for the facility usable by instances of the apparatus 100 (e.g., local network 404 illustrated in FIG. 4A). For example, the cellular type can be 2G, 3G, 4G, LTE, 5G, etc. The edge kit 172 is typically located near a facility’s primary Internet source 176 (e.g., a fiber backhaul or other similar device). Alternatively, a local network of the facility is configured to connect to the Internet using signals from a satellite source, transceiver, or router 178, especially in a remotely located facility not having a backhaul source, or where a mobile arrangement not requiring a wired connection is desired. More specifically, the satellite source plus edge kit 172 is, in embodiments, configured into a vehicle, or portable system. In embodiments, the cellular subsystem 105 is incorporated into a local or distributed cellular network operating on any of the existing 88 different Evolved Universal Mobile Telecommunications System Terrestrial Radio Access (EUTRA) operating bands (ranging from 700 MHz up to 2.7 GHz). For example, the apparatus 100 can operate using a duplex mode implemented using time division duplexing (TDD) or frequency division duplexing (FDD).

The Wi-Fi subsystem 106 enables the apparatus 100 to communicate with an access point 113 capable of transmitting and receiving data wirelessly in a relatively high-frequency band. In embodiments, the Wi-Fi subsystem 106 is also used in testing the apparatus 100 prior to deployment. The Bluetooth subsystem 108 enables the apparatus 100 to communicate with a variety of peripheral devices, including a biometric interface device 116 and a gas/chemical detection sensor 118 used to detect noxious gases. In embodiments, numerous other Bluetooth devices are incorporated into the apparatus 100.

As used herein, the wireless subsystems of the apparatus 100 include any wireless technologies used by the apparatus 100 to communicate wirelessly (e.g., via radio waves) with other apparatuses in a facility (e.g., multiple sensors, a remote interface, etc.), and optionally with the Internet (“the cloud”) for accessing websites, databases, etc. For example, the apparatus 100 can be capable of connecting with a conference call or video conference at a remote conferencing server. The apparatus 100 can interface with a conferencing software (e.g., Microsoft Teams^{TM}, Skype^{TM}, Zoom^{TM}, Cisco Webex^{TM}). The wireless subsystems 105, 106, and 108 are each configured to transmit/receive data in an appropriate format, for example, in IEEE 802.11, 802.15, 802.16 Wi-Fi standards, Bluetooth standard, WinnForum Spectrum Access System (SAS) test specification (WINNF-TS-0065), and across a desired range. In embodiments, multiple mobile radio devices are connected to provide data connectivity and data sharing. In embodiments, the shared connectivity is used to establish a mesh network.

The apparatus 100 communicates with a host server 170 which includes API software 128. The apparatus 100 communicates with the host server 170 via the Internet using pathways such as the Wi-Fi subsystem 106 through an access point 113 and/or the wireless antenna 174. The API 128 communicates with onboard software 115 to execute features disclosed herein.

The position tracking component 125 and the position estimating component 123 operate in concert. The position tracking component 125 is used to track the location of the apparatus 100. In embodiments, the position tracking component 125 is a GNSS (e.g., GPS, Quasi-Zenith Satellite System (QZSS), BEIDOU, GALILEO, GLONASS) navigational device that receives information from satellites and determines a geographic position based on the received information. The position determined from the GNSS navigation device can be augmented with location estimates based on waves received from proximate devices. For example, the position tracking component 125 can determine a location of the apparatus 100 relative to one or more proximate devices using receives signal strength indicator (RSSI) techniques, time difference of arrival (TDOA) techniques, or any other appropriate techniques. The relative position can then be combined with the position of the proximate devices to determine a location estimate of the apparatus 100, which can be used to augment or replace other location estimates. In embodiments, a geographic position is determined at regular intervals (e.g., every five minutes, every minute, every five seconds), and the position in between readings is estimated using the position estimating component 123.

Position data is stored in memory 114 and uploaded to server at regular intervals (e.g., every five minutes, every minute, every five seconds). In embodiments, the intervals for recording and uploading position data are configurable. For example, if the apparatus 100 is stationary for a predetermined duration, the intervals are ignored or extended, and new location information is not stored or uploaded. If no connectivity exists for wirelessly communicating with server 170, location data can be stored in memory 114 until connectivity is restored, at which time the data is uploaded and then deleted from memory 114. In embodiments, position data is used to determine latitude, longitude, altitude, speed, heading, and Greenwich mean time (GMT), for example, based on instructions of software 115 or based on external software (e.g., in connection with server 170). In embodiments, position information is used to monitor worker efficiency, overtime, compliance, and safety, as well as to verify time records and adherence to company policies.

In some embodiments, a Bluetooth tracking arrangement using beacons is used for position tracking and estimation. For example, the Bluetooth subsystem 108 receives signals from Bluetooth Low Energy (BLE) beacons located about the facility. The controller 110 is programmed to execute relational distancing software using beacon signals (e.g., triangulating between beacon distance information) to determine the position of the apparatus 100. Regardless of the process, the Bluetooth subsystem 108 detects the beacon signals and the controller 110 determines the distances used in estimating the location of the apparatus 100.

In alternative embodiments, the apparatus 100 uses Ultra-Wideband (UWB) technology with spaced-apart beacons for position tracking and estimation. The beacons are small, battery-powered sensors that are spaced apart in the facility and broadcast signals received by a UWB component included in the apparatus 100. A worker’s position is monitored throughout the facility over time when the worker is carrying or wearing the apparatus 100. As described herein, location-sensing GNSS and estimating systems (e.g., the position tracking component 125 and the position estimating component 123) can be used to primarily determine a horizontal location. In embodiments, the barometer 111 is used to determine a height at which the apparatus 100 is located (or operates in concert with the GNSS to determine the height) using known vertical barometric pressures at the facility. With the addition of a sensed height, a full three-dimensional location is determined by the processor 112. Applications of the embodiments include determining if a worker is, for example, on stairs or a ladder, atop or elevated inside a vessel, or in other relevant locations.

In embodiments, the display 130 is a touch screen implemented using a liquid-crystal display (LCD), an e-ink display, an organic light-emitting diode (OLED), or other digital display capable of displaying text and images. In embodiments, the display 130 uses a low-power display technology, such as an e-ink display, for reduced power consumption. Images displayed using the display 130 include, but are not limited to, photographs, video, text, icons, symbols, flowcharts, instructions, cues, and warnings.

The audio device 146 optionally includes at least one microphone (not shown) and a speaker for receiving and transmitting audible sounds, respectively. Although only one audio device 146 is shown in the architecture drawing of FIG. 1, it should be understood that in an actual physical embodiment, multiple speakers or microphones can be utilized to enable the apparatus 100 to adequately receive and transmit audio. In embodiments, the speaker has an output around 105 dB to be loud enough to be heard by a worker in a noisy facility. The microphone of the audio device 146 receives the spoken sounds and transmits signals representative of the sounds to the controller 110 for processing.

The apparatus 100 can be a shared device that is assigned to a particular user temporarily (e.g., for a shift). In embodiments, the apparatus 100 communicates with a worker ID badge using near field communication (NFC) technology. In this way, a worker may log in to a profile (e.g., stored at a remote server) on the apparatus 100 through their worker ID badge. The worker’s profile may store information related to the worker. Examples include name, employee or contractor serial number, login credentials, emergency contact(s), address, shifts, roles (e.g., crane operator), calendars, or any other professional or personal information. Moreover, the user, when logged in, can be associated with the apparatus 100. When another user logs in to the apparatus 100, however, that user can then be associated with the apparatus 100.

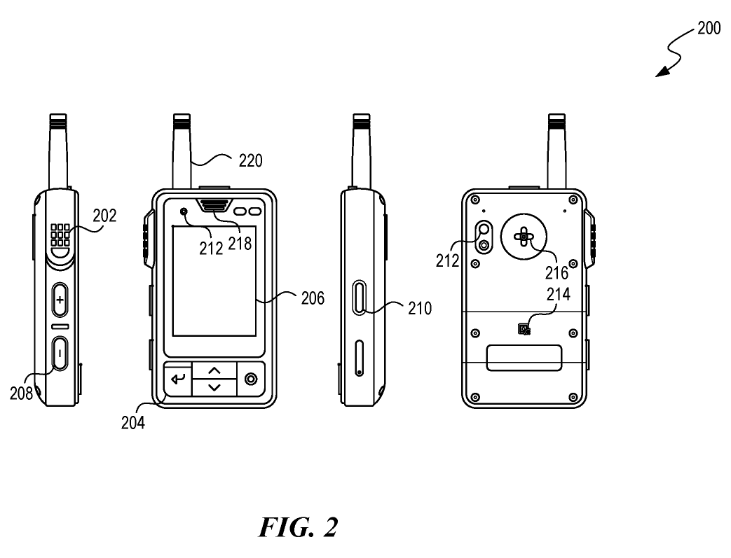

FIG. 2 is a drawing illustrating an example apparatus 200 for device communication and tracking, in accordance with one or more embodiments. The apparatus 200 includes a user interface that includes a PTT button 202, a 4-button user input system 204, a display 206, an easy to grab volume control 208, and a power button 210. The PTT button 202 can be used to control the transmission of data from or the reception of data by the apparatus 200. For example, the apparatus 200 may transmit audio data or other data when the PTT button 202 is pressed and receive audio data or other data when the PTT button 202 is released. In other examples, the PTT button 202 may control the transmission of audio data or other data from the apparatus 200 (e.g., transmit when the PTT button 202 is pressed), though apparatus 200 may transmit and receive audio data or other data at the same time (e.g., full duplex communication). The 4-button user input system 204 can be used to interact with the apparatus 200. For example, the 4-button user input system 204 can be used as a 4-direction input system (e.g., up-down-left-right), a 2-directional-enter-back (e.g., up-down-enter-back), or any other button configuration. The display 206 can output relevant visual information to the user. In aspects, the display 206 can enable touch input by the user to control the apparatus 200. The volume control 208 can control the loudness of the apparatus 200. The power button 210 can turn the apparatus 200 on and off.

The apparatus 200 further includes at least one camera 212, an NFC tag 214, a mount 216, at least one speaker 218, and at least one antenna 220. The camera 212 can be implemented as a front camera capturing the environment in front of the display 206 or a back camera capturing the environment opposite the display 206. The NFC tag 214 can be used to connect or register the apparatus 200. For example, the NFC tag 214 can register the apparatus 200 as being docked in a charging station. In yet another example, the NFC tag can connect to a workers badge to associate the apparatus with the worker. The mount 216 can be used to attach the apparatus 200 to the worker (e.g., on a utility belt of the worker). The speaker 218 can output audio received by or presented on the apparatus 200. The volume of the speaker 218 can be controlled by the volume control 208. The antenna 220 can be used to transmit data from the apparatus 200 or receive data at the apparatus 200. In some cases, transmission or reception by the antenna 220 can be controlled by the PTT button 202 or another button of the user interface.

### Charging Station

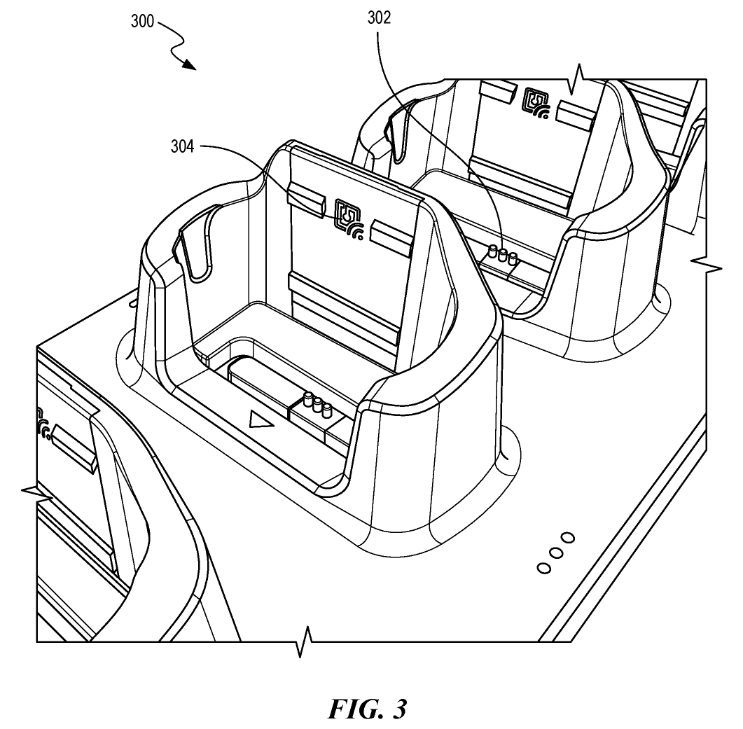

FIG. 3 is a drawing illustrating an example charging station 300 for apparatuses implementing device communication and tracking, in accordance with one or more embodiments. The charging station 300 can be used to dock one or more mobile radio devices for charging. In aspects, power can be supplied to the mobile radio devices docked at the charging station 300 through charging pins 302 located in each receptacle of the charging station 300. The charging pins 302 can be inserted into a charging port of the mobile radio devices. A worker clocking out at a facility can place a mobile radio device into the charging station 300. The mobile radio device can remain docked until it is removed from the charging station 300 by a worker clocking in at the facility.

The charging station 300 or the mobile radio device can determine when the mobile radio device has been docked in the charging station 300. For example, each receptacle of the charging station 300 can have an NFC pad 304 that connects with the mobile radio device when the mobile radio device is docked in that receptacle of the charging station 300. Alternatively or additionally, the mobile radio device can be determined to be docked in the charging station 300 when the charging pins 302 of a receptacle are inserted into the mobile radio device. In these ways, a cloud computing system can be made aware of the location and status (e.g., docked or removed) of the mobile radio device through communication with the charging station 300 or the mobile radio device.

### Communication Network

FIG. 4A is a drawing illustrating an example environment 400 for apparatuses and communication networks for device communication and tracking, in accordance with one or more embodiments. The environment 400 includes a cloud computing system 420, cellular transmission towers 412, 416, and local networks 404, 408. Components of the environment 400 are implemented using components of the example computer system illustrated and described in more detail with reference to subsequent figures. Likewise, different embodiments of the apparatus 100 include different and/or additional components and are connected in different ways.

Smart radios 424 (e.g., smart radios 424a-424c), smart radios 432 (e.g., smart radios 432a-b) and smart cameras 428, 436 are implemented in accordance with the architecture shown by FIG. 1. In embodiments, smart sensors implemented in accordance with the architecture shown by FIG. 1 are also connected to the local networks 404, 408 and mounted on a surface of a worksite, or worn or carried by workers. For example, the local network 404 is located at a first facility and the local network 408 is at a second facility. In embodiments, each smart radio and other smart apparatus has two Subscriber Identity Module (SIM) cards, sometimes referred to as dual SIM. A SIM card is an IC intended to securely store an international mobile subscriber identity (IMSI) number and its related key, which are used to identify and authenticate subscribers on mobile telephony devices.

A first SIM card enables the smart radio 424a to connect to the local (e.g., cellular) network 404 and a second SIM card enables the smart radio 424a to connect to a commercial cellular tower (e.g., cellular transmission tower 412) for access to mobile telephony, the Internet, and the cloud computing system 420 (e.g., to major participating networks such as Verizon™, AT&T™, T-Mobile™, or Sprint™). In such embodiments, the smart radio 424a has two radio transceivers, one for each SIM card. In other embodiments, the smart radio 424a has two active SIM cards, and the SIM cards both use only one radio transceiver. However, the two SIM cards are both active only as long as both are not in simultaneous use. As long as the SIM cards are both in standby mode, a voice call could be initiated on either one. However, once the call begins, the other SIM card becomes inactive until the first SIM card is no longer actively used.

In embodiments, the local network 404 uses a private address space of Internet protocol (IP) addresses. In other embodiments, the local network 404 is a local radio-based network using peer-to-peer (P2P) two-way radio (duplex communication) with extended range based on hops (e.g., from smart radio 424a to smart radio 424b to smart radio 424c). Hence, radio communication is transferred similarly to addressed packet-based data with packet switching by each smart radio or other smart apparatus on the path from source to destination. For example, each smart radio or other smart apparatus operates as a transmitter, receiver, or transceiver for the local network 404 to serve a facility. The smart apparatuses serve as multiple transmit/receive sites interconnected to achieve the range of coverage required by the facility. Further, the signals on the local networks 404, 408 are backhauled to a central switch for communication to the cellular transmission towers 412, 416.

In embodiments (e.g., in more remote locations), the local network 404 is implemented by sending radio signals between multiple smart radios 424. Such embodiments are implemented in less-inhabited locations (e.g., wilderness) where workers are spread out over a larger work area that may be otherwise inaccessible to commercial cellular service. An example is where power company technicians are examining or otherwise working on power lines over larger distances that are often remote. The embodiments are implemented by transmitting radio signals from a smart radio 424a to other smart radios 424b, 424c on one or more frequency channels operating as a two-way radio. The radio messages sent include a header and a payload. Such broadcasting does not require a session or a connection between the devices. Data in the header is used by a receiving smart radio 424b to direct the “packet” to a destination (e.g., smart radio 424c). At the destination, the payload is extracted and played back by the smart radio 424c via the radio’s speaker.

For example, the smart radio 424a broadcasts voice data using radio signals. Any other smart radio 424b within a range limit (e.g., 1 mile , 2 miles, etc.) receives the radio signals. The radio data includes a header having the destination of the message (smart radio 424c). The radio message is decrypted/decoded and played back on only the destination smart radio 424c. If another smart radio 424b that was not the destination radio receives the radio signals, the smart radio 424b rebroadcasts the radio signals rather than decoding and playing them back on a speaker. The smart radios 424 are thus used as signal repeaters. The advantages and benefits of the embodiments disclosed herein include extending the range of two-way radios or smart radios 424 by implementing radio hopping between the radios.

In embodiments, the local network 404 is implemented using Citizens Broadband Radio Service (CBRS). The use of CBRS Band 48 (from 3550 MHz to 3700 MHz), in embodiments, provides numerous advantages. For example, the use of CBRS Band 48 provides longer signal ranges and smoother handovers. The use of CBRS Band 48 supports numerous smart radios 424 and smart cameras 428 at the same time. A smart apparatus is therefore sometimes referred to as a Citizens Broadband Radio Service Device (CBSD).

In alternative embodiments, the Industrial, Scientific, and Medical (ISM) radio bands are used instead of CBRS Band 48. It should be noted that the particular frequency bands used in executing the processes herein could be different, and that the aspects of what is disclosed herein should not be limited to a particular frequency band unless otherwise specified (e.g., 4G-LTE or 5G bands could be used). In embodiments, the local network 404 is a private cellular (e.g., LTE) network operated specifically for the benefit of the facility. Only authorized users of the smart radios 424 have access to the local network 404. For example, the local network 404 uses the 900 MHz spectrum. In another example, the local network 404 uses 900 MHz for voice and narrowband data for Land Mobile Radio (LMR) communications, 900 MHz broadband for critical wide area, long-range data communications, and CBRS for ultra-fast coverage of smaller areas of the facility, such as substations, storage yards, and office spaces.

The smart radios 424 can communicate using other communication technologies, for example, Voice over IP (VoIP), Voice over Wi-Fi (VoWiFi), or Voice over Long-Term Evolution (VoLTE). The smart radios 424 can connect to a communication session (e.g., voice call, video call) for real-time communication with specific devices. The communication sessions can include devices within or outside of the local network 404 (e.g., in the local network 408). The communication sessions can be hosted on a private server (e.g., of the local network 404) or a remote server (e.g., accessible through the cloud computing system 420). In other aspects, the session can be P2P.

The cloud computing system 420 delivers computing services—including servers, storage, databases, networking, software, analytics, and intelligence—over the Internet to offer faster innovation, flexible resources, and economies of scale. FIG. 4A depicts an exemplary high-level, cloud-centered network environment 400 otherwise known as a cloud-based system. Referring to FIG. 4A, it can be seen that the environment centers around the cloud computing system 420 and the local networks 404, 408. Through the cloud computing system 420, multiple software systems are made to be accessible by multiple smart radios 424, 432, smart cameras 428, 436, as well as more standard devices (e.g., a smartphone 440 or a tablet) each equipped with local networking and cellular wireless capabilities. Each of the apparatuses 424, 428, 440, although diverse, can embody the architecture of the apparatus 100 shown by FIG. 1, but are distributed to different kinds of users or mounted on surfaces of the facility. For example, the smart radio 424a is worn by employees or independently contracted workers at a facility. The CBRS-equipped smartphone 440 is utilized by an on- or offsite supervisor. The smart camera 428 is utilized by an inspector or another person wanting to have improved display or other options. Regardless, it should be recognized that numerous apparatuses are utilized in combination with an established cellular network (e.g., CBRS Band 48 in embodiments) to provide the ability to access the cloud software applications from the apparatuses (e.g., smart radios 424, 432, smart cameras 428, 436, smartphone 440).

In embodiments, the cloud computing system 420 and local networks 404, 408 are configured to send communications to the smart radios 424, 432 or smart cameras 428, 436 based on analysis conducted by the cloud computing system 420. The communications enable the smart radio 424 or smart camera 428 to receive warnings, etc., generated as a result of analysis conducted. The employee-worn smart radio 424a (and possibly other devices including the architecture of the apparatus 100, such as the smart cameras 428, 436) is used along with the peripherals shown in FIG. 1 to accomplish a variety of objectives. For example, workers, in embodiments, are equipped with a Bluetooth-enabled gas-detection smart sensor. The smart sensor detects the existence of a dangerous gas, or gas level. By connecting through the smart radio 424a or directly to the local network 404, the readings from the smart sensor are analyzed by the cloud computing system 420 to implement a course of action due to sensed characteristics of toxicity. The cloud computing system 420 sends out an alert to the smart radio 424 or smart camera 428, and thus a worker, for example, uses a speaker or alternative notification means to alert other workers so that they can avoid danger.

### Position Estimation

The environment 400 can include one or more satellites 444. The smart radios 424 can receive signals from the satellites 444 that are usable to determine position estimates. For example, the smart radios 424 include a positioning system that implements a GNSS or other network triangulation/position system. In some embodiments, the locations of the smart radios 424 are determined from satellites, for example, GPS, QZSS, BEIDOU, GALILEO, and GLONASS. In some cases, the position determined from the primary positioning system does not satisfy a minimum accuracy requirement, the primary position can only be determined at predetermined intervals, or the primary position cannot be determined at all. Accordingly, additional positioning techniques can be used to augment or replace primary positioning. For example, the smart radio 424a can track its position based on broadcast signals received from proximate devices (e.g., using RSSI techniques or TDOA techniques). In some embodiments, the proximate devices include devices that have transmission ranges that encompass the location of the smart radio 424a (e.g., smart radios 424b, 424c). In some embodiments, the smart radios 424 determine or augment a secondary position estimate based on broadcasts received from a cellular communication tower (e.g., cellular transmission tower 412).

RSSI techniques include using the strength signals within a broadcast signal to determine the distance of a receiver from a transmitter. For instance, a receiver is enabled to determine the signal-to-noise ratio (SNR) of a received signal within a broadcast from a transmitter. The SNR of receive signal can be related to the distance between a receiver and a transmitter. Thus, the distance between the receiver and the transmitter can be estimated based on the SNR. By determining a receiver’s distance from multiple transmitters, the receiver’s position can be determined through localization (e.g., triangulation). In some cases, RSSI techniques become less accurate at larger distances. Accordingly, proximate devices may be required to be within a particular distance for RSSI techniques.

TDOA techniques include using the timing at which broadcast signals are received to determine the distance of a receiver from a transmitter. For example, a broadcast signal is sent by a transmitter at a known time (e.g., predetermined intervals). Thus, by determining the time at which the broadcast signal is received (e.g., using a clock), the travel time of the broadcast signal can be determined. The distance of the smart radios 424 from one another can thus be determined based on the wave speed. In some implementations, as broadcast signals are received from the transmitters, the smart radios 424 determine its relative position from each transmitter through localization, resulting in a more accurate global position (e.g., triangulation). Thus, TDOA techniques can be used to determine device location.

In aspects, the broadcast signals transmitted by proximate devices include information related to a position. For example, broadcast signals sent from the smart radios 424 identify their current location. Broadcast signals sent from cellular communication towers or other stationary devices may not need to include a current location, as the location may be known to the receiving device. In other cases, a cellular communication tower or other stationary device sends a broadcast signal that includes information indicative of a current location of the tower or stationary device. Using the current location of the transmitting devices and the location of the smart radios (e.g., smart radios 424b, 424c) relative to the transmitting devices, a global position of the smart radio 424a can be determined.

In some cases, a barometer is used to augment the position determination of the smart radios 424. For example, RSSI, TDOA, and other techniques are used to determine the distance between a transmitter and a receiver. However, these techniques may not provide information related to the displacement between the transmitter and the receiver (e.g., whether the distance is in the x, y, or z plane). In some cases, the barometer is used to provide relative displacement information (e.g., based on atmospheric conditions) of the smart radios 424. In aspects, the broadcast signals received from the proximate devices include information relating to respective elevation estimates (e.g., determined by barometers at the proximate devices) at each of the proximate devices. The elevation estimates from the proximate devices are compared to the elevation estimate of the smart radio 424a to determine the difference in elevation between the smart radio 424a and the proximate devices (e.g., smart radios 424b, 424c).

In some cases, a target device estimates a location based on proximate devices without analyzing broadcast signals. For example, proximate devices shares their calculated location data. The target device (e.g., smart radio 424a) receives location data via any communication technology (e.g., Bluetooth or another short-range communication). One device (e.g., smart radio 424b) shares that it is at location A and another device (e.g., smart radio 424c) is at location B. The target device estimates that it’s located somewhere near A and B (e.g., within a communication range of A and B using the respective communication mechanism). In another aspect, the target device receives location data from multiple proximate devices and combines (e.g., average) the location data to estimate its position. In yet another example, the target device receives location data from proximate devices via a first communication and uses a second communication to determine the location of the target device relative to the proximate devices. In this way, the location data need not be communicated in the same communication used to determine the relative location of the target device.

As an example, the smart radio 424b determines its location based on a primary location estimate that is augmented with a secondary location estimate. For example, the smart radio 424b receives a primary location estimate. In aspects, the primary location estimate is a GNSS location determined from the satellite 444 or a location estimate determined by communications with the cellular communication tower 412 (e.g., using TDOA, RSSI, or other techniques). In some implementations, the primary location estimate has a measurement error less than 1 foot, 2 feet, 5 feet, 10 feet, or the like. The measurement error may increase based on an environment of the smart radio 424b. For example, the measurement error may be higher if the smart radio 424b is within or surrounded by a densely constructed building.

To improve the measurement accuracy, the smart radio 424b can augment its primary location estimate based on a secondary location estimate. In aspects, the secondary location estimate is determined from broadcast signals transmitted by smart radio 424a, smart radio 424c, smart camera 428, cellular communication tower 412, or another communication device or node (e.g., an access point). Positioning techniques (e.g., TDOA, RSSI, location sharing, or other techniques) can be used to determine a relative distance from the transmitting device. For example, smart radio 424a, smart radio 424c, and smart camera 428 transmit broadcast signals that enable the distance of the smart radio 424b to be determined relative to each transmitting device. The transmitting devices can be stationary or moving. Stationary objects typically have strong or high confidence location data (e.g., immobile objects are plotted accurately to maps). The relative location of the smart radio 424b is determined through triangulation based on the distance from each transmitting device. In aspects, the secondary location estimate has a measurement error of less than 1 inch, 2 inches, 6 inches, or 1 foot. In aspects, the secondary location estimate replaces with the primary location estimate or is averaged with the primary location estimate to determine an augmented position estimate with reduced error. Accordingly, the measurement error of the location estimate of the smart device 424b can be improved by augmenting the primary location estimate with the secondary location estimate.

In some implementations, the location of the equipment is similarly monitored. In this context, mobile equipment refers to worksite or facility industrial equipment (e.g., heavy machinery, precision tools, construction vehicles). According to example embodiments, a location of a mobile equipment is continuously monitored based on repeated triangulation from multiple smart radios 424 located near the mobile equipment (e.g., using tags placed on the mobile equipment). Improvements to the operation and usage of the mobile equipment are made based on analyzing the locations of the mobile equipment throughout a facility or worksite. Locations of the mobile equipment are reported to owners of the mobile equipment or entities that own, operate, and/or maintain the mobile equipment. Mobile equipment whose location is tracked includes vehicles, tools used and shared by workers in different facility locations, toolkits and toolboxes, manufactured and/or packaged products, and/or the like. Generally, mobile equipment is movable between different locations within the facility or worksite at different points in time.

Various monitoring operations are performed based on the locations of the mobile equipment that are determined over time. In some embodiments, a usage level for the mobile equipment is automatically classified based on different locations of the mobile equipment over time. For example, a mobile equipment having frequent changes in location within a window of time (e.g., different locations that are at least a threshold distance away from each other) is classified at a high usage level compared to a mobile equipment that remains in approximately the same location for the window of time. In some embodiments, certain mobile equipment classified with high usage levels are indicated and identified to maintenance workers such that usage-related failures or faults can be preemptively identified.

In some embodiments, a resting or storage location for the mobile equipment is determined based on the monitoring of the mobile equipment location. For example, an average spatial location is determined from the locations of the mobile equipment over time. A storage location based on the average spatial location is then indicated in a recommendation provided or displayed to an administrator or other entity that manages the facility or worksite.

In some embodiments, locations of multiple mobile equipment are monitored so that a particular mobile equipment is recommended for use to a worker during certain events or scenarios. As another example, for a worker assigned with a maintenance task at a location within a facility, one or more maintenance toolkits shared among workers and located near the location are recommended to the worker for use.

Accordingly, embodiments described herein provide local detection and monitoring of mobile equipment locations. Facility operation efficiency is improved based on the monitoring of mobile equipment locations and analysis of different mobile equipment locations.

### Machine-Defined Interactions

The cloud computing system 420 uses data received from the smart radios 424, 432 and smart cameras 428, 436 to track and monitor machine-defined activity of workers based on locations worked, times worked, analysis of video received from the smart cameras 428, 436, etc. The activity is measured by the cloud computing system 420 in terms of at least one of a start time, a duration of the activity, an end time, an identity (e.g., serial number, employee number, name, seniority level, etc.) of the worker performing the activity, an identity of the equipment(s) used by the worker, or a location of the activity. For example, a smart radio 424a carried or worn by a worker would track that the position of the smart radio 424a is in proximity to or coincides with a position of the particular machine.

The activity is measured by the cloud computing system 420 in terms of at least the location of the activity and one of a duration of the activity, an identity of the worker performing the activity, or an identity of the equipment(s) used by the worker. In embodiments, the ML system is used to detect and track activity, for example, by extracting features based on equipment types or manufacturing operation types as input data. For example, a smart sensor mounted on an oil rig transmits to and receives signals from a smart radio 424a carried or worn by a worker to log the time the worker spends at a portion of the oil rig.

Worker activity involving multiple workers can similarly be monitored. These activities can be measured by the cloud computing system 420 in terms of at least one of a start time, a duration of the activity, an end time, identities (e.g., serial numbers, employee numbers, names, seniority levels, etc.) of the workers performing the activity, an identity of the equipment(s) used by the workers, or a location of the activity. Group activities are detected and monitored using location tracking of multiple smart apparatuses. For example, the cloud computing system 420 tracks and records a specific group activity based on determining that two or more smart radios 424 were located in proximity to one another within a particular worksite for a predetermined period of time. For example, a smart radio 424a transmits to and receives signals from other smart radios 424b, 424c carried or worn by other workers to log the time the worker spends working together in a team with the other workers.

In embodiments, a smart camera 428 mounted at the worksite captures video of one or more workers working in the facility and performs facial recognition (e.g., using the ML system). The smart camera 428 can identify the equipment used to perform an activity or the tasks that a worker is performing. The smart camera 428 sends the location information to the cloud computing system 420 for generation of activity data. In embodiments, an ML system is used to detect and track activity (e.g., using features based on geographic locations or facility types as input data).

The cloud computing system 420 can determine various metrics for monitored workers based on the activity data. For example, the cloud computing system 420 can determine a response time for a worker. The response time refers to the time difference between receiving a call to report to a given task and the time of arriving at a geofence associated with the task. In aspects, the cloud computing system 420 can determine a repair metric, which measures the effectiveness of repairs by a worker, based on the activity data. For example, the effectiveness of repairs is machine observable based on a length of time a given object remains functional as compared to an expected time of functionality (e.g., a day, a few months, a year, etc.). In yet another aspect, the activity data can be analyzed to determine efficient routes to different areas of a worksite, for example, based on routes traveled by monitored workers. Activity data can be analyzed to determine the risk to which each worker is exposed, for example, based on how much time a worker spends in proximity to hazardous material or performing hazardous tasks. The ML system can analyze the various metrics to monitor workers or reduce risk.

### Worker Experience Profile

The cloud computing system 420 hosts the software functions to track activities to determine performance metrics and time spent at different tasks and with different equipment and to generate work experience profiles of frontline workers based on interfacing between software suites of the cloud computing system 420 and the smart radios 424, 432, smart cameras 428, 436, smartphone 440. Tracking of activities is implemented in, for example, Scheduling Systems (SS), Field Data Management (FDM) systems, and/or Enterprise Resource Planning (ERP) software systems that are used to track and plan for the use of facility equipment and other resources. Manufacturing Management System (MMS) software is used to manage the production and logistics processes in manufacturing industries (e.g., for the purpose of reducing waste, improving maintenance processes and timing, etc.). Risk-Based Inspection (RBI) software assists the facility using optimized maintenance business processes to examine equipment and/or structures, and track activities prior to and after a breakdown in equipment, detection of manufacturing failures, or detection of operational hazards (e.g., detection of gas leaks in the facility). The amount of time each worker logs at a machine-defined activity with respect to different locations and different types of equipment is collected and used to update an “experience profile” of the worker on the cloud computing system 420 in real time.

FIG. 4B is a flow diagram illustrating an example process for generating a work experience profile using smart radios 424a, 424b, and local networks 404, 408 for device communication and tracking, in accordance with one or more embodiments. The smart radios 424 and local networks 404, 408 are illustrated and described in more detail with reference to FIG. 4A. In embodiments, the process of FIG. 4B is performed by the cloud computing system 420 illustrated and described in more detail with reference to FIG. 4A. In embodiments, the process of FIG. 4A is performed by a computer system, for example, the example computer system illustrated and described in more detail with reference to subsequent figures. Particular entities, for example, the smart radios 424 or the local network 404, perform some or all of the steps of the process in embodiments. Likewise, embodiments can include different and/or additional steps, or perform the steps in different orders.

At 472, the cloud computing system 420 obtains locations and time-logging information from multiple smart apparatuses (e.g., smart radios 424) located at a facility. The locations describe movement of the multiple smart apparatuses with respect to the time-logging information. For example, the cloud computing system 420 keeps track of shifts, types of equipment, and locations worked by each worker, and uses the information to develop the experience profile automatically for the worker, including formatting services. When the worker joins an employer or otherwise signs up for the service, relevant personal information is obtained by the cloud computing system 420 to establish payroll and other known employment particulars. The worker uses a smart radio 424a to engage with the cloud computing system 420 and works shifts for different positions.

At 476, the cloud computing system 420 determines activity of a worker based on the locations and the time-logging information. The activities describe work performed by one or more workers with equipment of the facility (e.g., lathes, lifts, crane, etc.). For example, the activities can include tasks performed by the worker, equipment worked with by the worker, time spent on a task or with a piece of equipment, or any other relevant information. In some cases, the activities can be used to log accidents that occur at the worksite. The activities can also include various performance metrics determined from the location and the time-logging information.

At 480, the cloud computing system 420 generates the experience profile of the worker based on the activity of the worker. The cloud computing system 420 automatically fills in information determined from the activity of the worker to build the experience profile of the worker. The data filled into the field space of the experience profile can include the specific number of hours that a worker has spent working with a particular type of equipment (e.g., 200 hours spent driving forklifts, 150 hours spent operating a lathe, etc.). The experience profile can further include various performance metrics associated with a particular task or piece of equipment. In embodiments, the cloud computing system 420 exports or publishes the experience profile to a user profile of a social or professional networking platform (e.g., such as LinkedIn^{TM}, Monster^{TM}, any other suitable social media or proprietary website, or a combination thereof). In embodiments, the cloud computing system 420 exports the experience profile in the form of a recommendation letter or reference package to past or prospective employers. The experience data enables a given worker to prove that they have a certain amount of experience with a given equipment platform.

### Example Facility

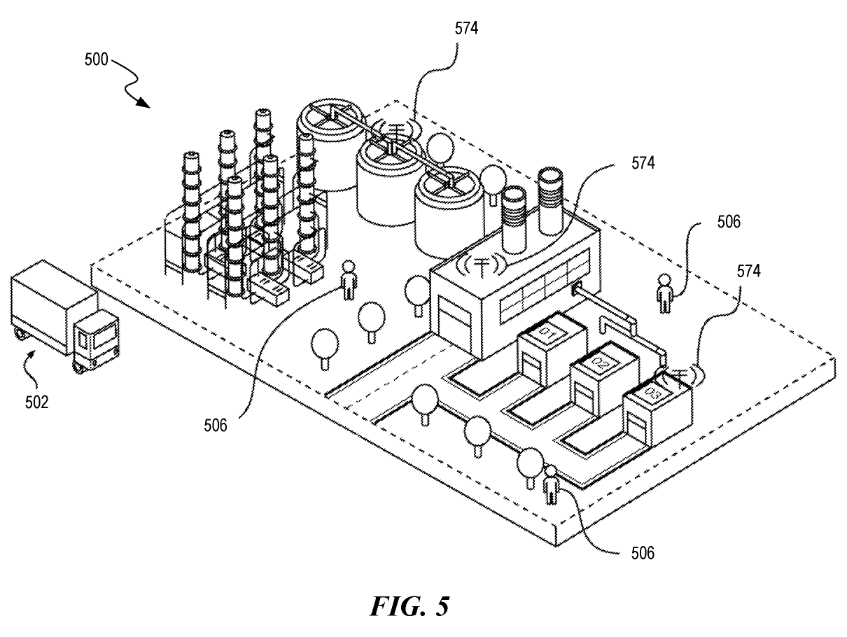

FIG. 5 is a drawing illustrating an example facility 500 using apparatuses and communication networks for device communication and tracking, in accordance with one or more embodiments. For example, the facility 500 is a refinery, a manufacturing facility, a construction site, etc. The communication technology shown by FIG. 5 can be implemented using components of the example computer systems illustrated and described in more detail with reference to the other figures herein.

Multiple differently and strategically placed wireless antennas 574 are used to receive signals from an Internet source (e.g., a fiber backhaul at the facility), or a mobile system (e.g., a truck 502). The truck 502, in embodiments, can implement an edge kit used to connect to the Internet. The strategically placed wireless antennas 574 repeat the signals received and sent from the edge kit such that a private cellular network is made available to multiple workers 506. Each worker carries or wears a cellular-enabled smart radio, implemented in accordance with the embodiments described herein. A position of the smart radio is continually tracked during a work shift.

In implementations, a stationary, temporary, or permanently installed cellular (e.g., LTE or 5G) source is used that obtains network access through a fiber or cable backhaul. In embodiments, a satellite or other Internet source is embodied into hand-carried or other mobile systems (e.g., a bag, box, or other portable arrangement). FIG. 5 shows that multiple wireless antennas 574 are installed at various locations throughout the facility. Where the edge kit is located at a location near a facility fiber backhaul, the communication system in the facility 500 uses multiple omnidirectional Multi-Band Outdoor (MBO) antennas as shown. Where the Internet source is instead located near an edge of the facility 500, as is often the case, the communication system uses one or more directional wireless antennas to improve the coverage in terms of bandwidth. Alternatively, where the edge kit is in a mobile vehicle, for example, truck 502, the antennas’ directional configuration would be picked depending on whether the vehicle would ultimately be located at a central or boundary location.

In embodiments where a backhaul arrangement is installed at the facility 500, the edge kit is directly connected to an existing fiber router, cable router, or any other source of Internet at the facility. In embodiments, the wireless antennas 574 are deployed at a location in which the smart radio is to be used. For example, the wireless antennas 574 are omnidirectional, directional, or semidirectional depending on the intended coverage area. In embodiments, the wireless antennas 574 support a local cellular network. In embodiments, the local network is a private LTE network (e.g., based on 4G or 5G). In more specific embodiments, the network is a CBRS Band 48 local network. The frequency range for CBRS Band 48 extends from 3550 MHz to 3700 MHz and is executed using TDD as the duplex mode. The private LTE wireless communication device is configured to operate in the private network created, for example, to accommodate CBRS Band 48 in the frequency range for Band 48 (again, from 3550 MHz to 3700 MHz) and accommodates TDD. Thus, channels within the preferred range are used for different types of communications between the cloud and the local network.

### Geofencing

As described herein, smart radios are configured with location estimating capabilities and are used within a facility or worksite for which geofences are defined. A geofence refers to a virtual perimeter for a real-world geographic area, such as a portion of a facility or worksite. A smart radio includes location-aware devices that inform of the location of the smart radio at various times. Embodiments described herein relate to location-based features for smart radios or smart apparatuses. Location-based features described herein use location data for smart radios to provide improved functionality. In some embodiments, a location of a smart radio (e.g., a position estimate) is assumed to be representative of a location of a worker using or associated with the smart radio. As such, embodiments described herein apply location data for smart radios to perform various functions for workers of a facility or worksite.

Some example scenarios that require radio communication between workers are area-specific, or relevant to a given area of a facility. For example, when machines need repair, workers near the machine can be notified and provided instructions to assist in the repair. Alternatively, if a hazard is present at the facility, workers near the hazard can be notified.

According to some embodiments, locations of smart radios are monitored such that at a point in time, each smart radio located in a specific geofenced area is identified.

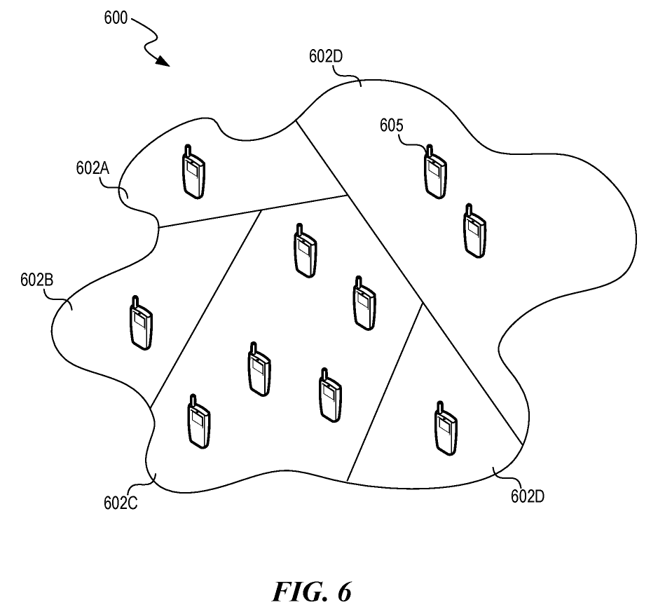

FIG. 6 illustrates an example of a worksite 600 that includes a plurality of geofenced areas 602, with smart radios 605 being located within the geofenced areas 602.

In some embodiments, an alert, notification, communication, and/or the like is transmitted to each smart radio 605 that is located within a geofenced area 602 (e.g., 602C) responsive to a selection or indication of the geofenced area 602. A smart radio 605, an administrator smart radio (e.g., a smart radio assigned to an administrator), or the cloud computing system is configured to enable user selection of one of the plurality of geofenced areas 602 (e.g., 602C). For example, a map display of the worksite 600 and the plurality of geofenced areas 602 is provided. With the user selection of a geofenced area 602 and a location for each smart radio 605, a set of smart radios 605 located within the geofenced area 602 is identified. An alert, notification, communication, and/or the like is then transmitted to the identified smart radios 605.

### Monitoring User Activity Within a Geofenced Environment

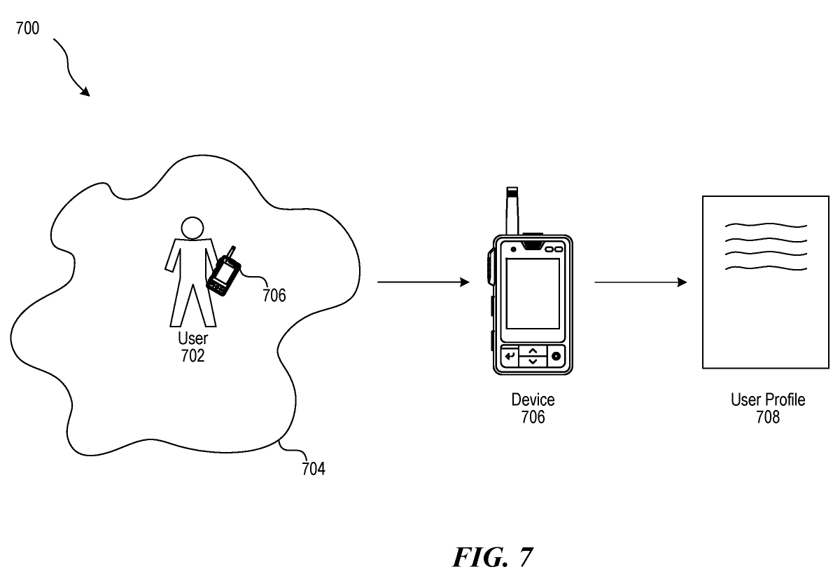

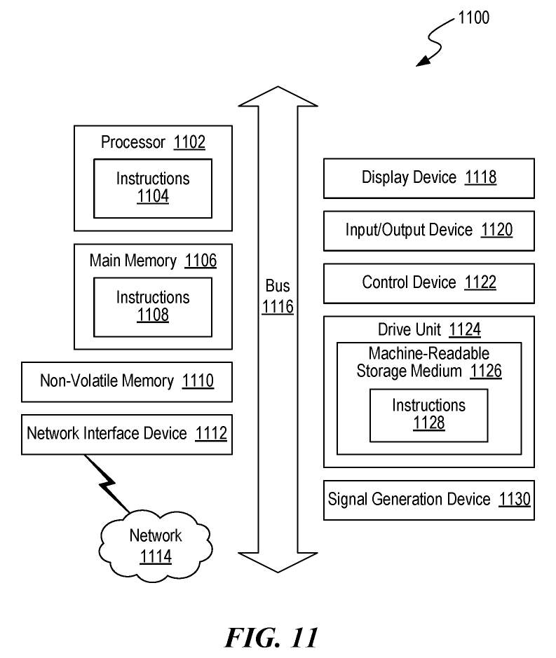

FIG. 7 is a block diagram illustrating an example architecture 700 for generating a user profile based on user activity within a geofenced environment, in accordance with one or more embodiments. Example architecture 700 includes user 702, geofenced area 704, device 706, and user profile 708. Device 706 is implemented using components of the example computer system 1100 illustrated and described in more detail with reference to FIG. 11. Embodiments of example architecture 700 can include different and/or additional components or can be connected in different ways.

The user 702 refers to an individual whose activity is being monitored within the geofenced area 704. In some embodiments, the user 702 is a worker in a facility, a field technician, or any individual whose movement and activity are tracked for safety, productivity, or other purposes. The geofenced area 704 is the same as or similar to the geofenced area 602 discussed in further detail with reference to FIG. 6.

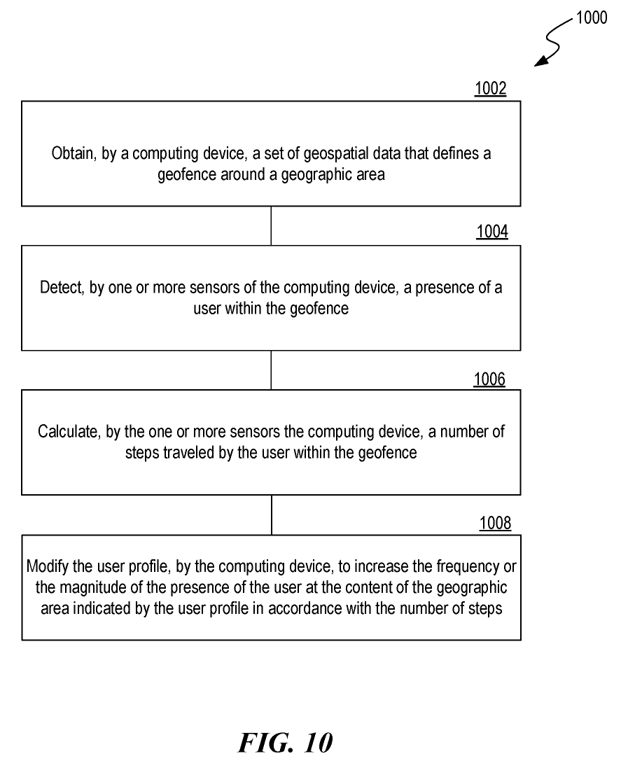

The device 706 is a portable computing device carried on the user’s 702 person and used to monitor the user 702. Device 706 can be the same as or similar to apparatus 100 and/or apparatus 200 discussed further with reference to FIG. 1 and FIG. 2, respectively. The device 706 is, for example, a smart radio, a wearable device, or other mobile apparatus used within the worksite equipped with sensors such as accelerometers, GPS modules, and/or gyroscopes. The device 706 obtains geospatial data that defines the geofence around a geographic area and detects the presence of the user 702 within the geofenced area 704. The device 706 calculates the number of steps traveled by the user 702 based on changes in location or speed and communicates the data to a host server of the device 706. The device 706 dynamically adjusts the geofenced area 704 based on predefined criteria such as time of day, environmental conditions, or the frequency of the user 702's presence using methods discussed with reference to FIG. 10.

In some embodiments, the device 706 uses wireless location tracking by periodically sending out signals to nearby devices, such as other smart radios, access points, or fixed beacons within the geofenced area 704. By measuring the received signal strength indicator (RSSI) of the returned signals, the device 706 estimates the device’s 706 distance from these neighboring devices. The system uses the distance estimates to triangulate the location of the device 706 within the geofenced area. For example, RSSI measurements are useful in environments where GPS signals are weak or obstructed, such as indoors or in areas with dense infrastructure. In some embodiments, the RSSI measurements are combined with data from the device’s 706 other sensors.

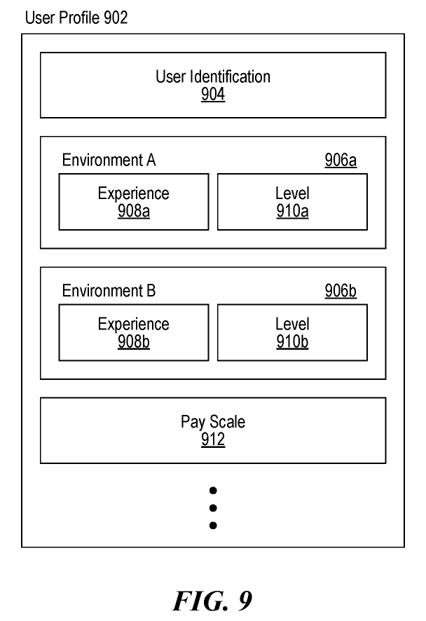

The user profile 708 is a digital record associated with the user 702, stored on the host server. The user profile 708 indicates the frequency or magnitude of the presence of the user 702 at the content of the geofenced area 704. User profile 708 is updated based on the data received from the device 706, reflecting the increased frequency or magnitude of the user 702's presence in the geofenced area 704. In some embodiments, the user profile 708 includes, in some embodiments, additional information such as work history, productivity metrics, and/or experience levels. Examples of user profile are discussed in further detail with reference to user profile 902 in FIG. 9. The continuous updating of the user profile 708 ensures that the user profile 708 remains an accurate representation of the user 702's activities and experiences within the geofenced environment.

In some embodiments, the user profile 708 is a resume. The resume includes various metrics, such as the number of steps taken, distance traveled, and time spent in different zones to demonstrate the user's experience and proficiency in the specific content of the geographic area. The resume is used for performance evaluations, career development, and/or demonstrating the user's capabilities to potential employers. In some embodiments, the resume is dynamically updated as new data is collected using methods further discussed with reference to FIG. 10, ensuring that the resume reflects the most current information about the user's activities and achievements.

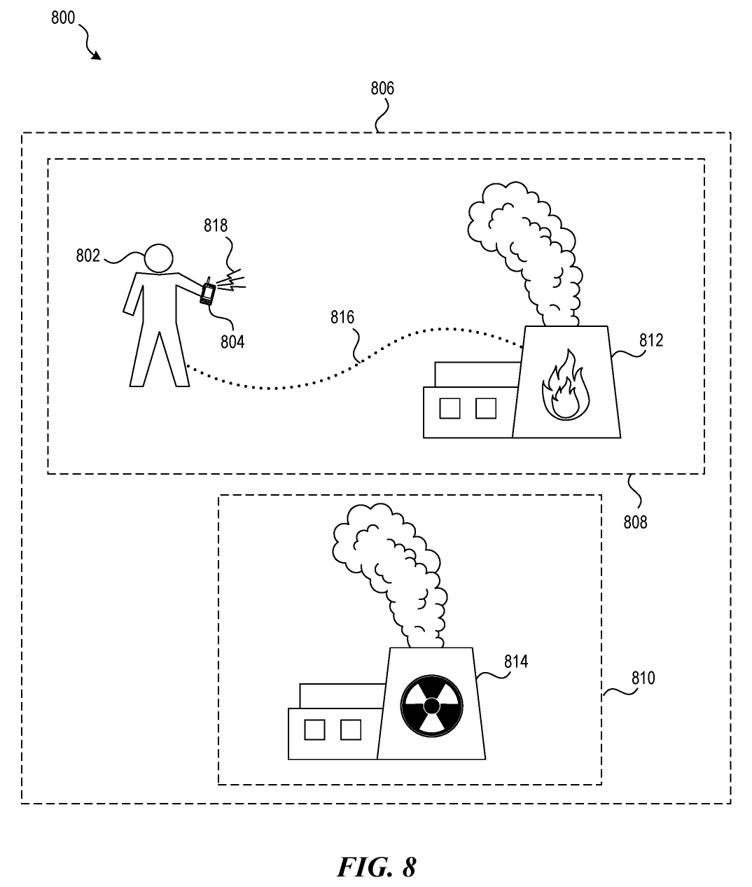

FIG. 8 is a block diagram illustrating an example environment 800 for monitoring user activity within a geofenced environment, in accordance with one or more embodiments. Example environment 800 includes user 802, device 804, first geofence 806, second geofence 808, third geofence 810, worksites (e.g., first worksite 812, second worksite 814), traveled path 816, and notification 818. Device 804 can be the same as or similar to device 706 discussed further with reference to FIG. 7. Device 804 is implemented using components of the example computer system 1100 illustrated and described in more detail with reference to FIG. 11. Embodiments of example environment 800 can include different and/or additional components or can be connected in different ways.

Geofences (e.g., first geofence 806, second geofence 808, third geofence 810) are the same as or similar to geofenced area 704 in FIG. 7. First geofence 806 is a virtual perimeter that outlines a specific geographic area within the worksite. In some embodiments, a network administrator defines the first geofence 806 by specifying the latitude and longitude coordinates that form the boundary of the geofence using, for example, a mapping interface, imported geographic data files (e.g., KML, GeoJSON), and/or GPS coordinate data. In some embodiments, the network administrator defines the geofences via free hand drawn polygons on the mapping interface, and the mapping interface translates to geospatial coordinates. The first geofence 806 enables the system to identify when user 802 enters or exits the area.

Second geofence 808 and third geofence 810 are different virtual perimeters that outline a smaller geographic area within the first geofence 806. The second geofence 808 and third geofence 810 is defined using the same or similar methods as the first geofence 806. The hierarchical structure of nesting multiple smaller geofences within a larger geofence (e.g., first geofence 806) enables more granular monitoring of user 802's movements and activities across different zones within the worksite. For example, a large manufacturing plant with multiple departments and zones (e.g., smelting plant 812, chemical plant 814) is defined by a larger geofence 806 that encompasses the entire manufacturing plant, which enables the system to determine the user 802's presence within the plant. In some embodiments, the first geofence 806, the second geofence 808, and/or the third geofence 810 are dynamically adjustable based on predefined criteria such as time of day, environmental conditions, or user activity patterns.

Worksites, such as first worksite 812 and second worksite 814, are the physical locations where user 802 performs tasks. The worksites 812, 814 are mapped and divided into corresponding geofenced areas (e.g., second geofence 808, third geofence 810, respectively) to facilitate detailed monitoring of user activity. For example, the first worksite 812 is a smelting plant, while second worksite 814 is a chemical plant. The system tracks user 802's movements within and between the worksites 812, 814. Traveled path 816 represents the route taken by user 802 within the geofenced environment. The number of steps on traveled path 816 is determined based on the geospatial data and sensor readings from device 804 using methods discussed with reference to FIG. 10.

In FIG. 8, the larger geofence (e.g., geofence 806) encompasses the entire industrial complex, including both the smelting plant (worksite 812) and the chemical plant (worksite 814). The larger geofence allows the system to track, for example, the total time/number of steps a user 802 spends within the overall industrial complex. Further, the smaller geofences (e.g., geofences 808 and 810) that specifically outline individual worksites enables the system to monitor the user’s 802 activity/time allocation across different types of worksites.

A step is a unit of measurement used to quantify the user’s activity within the geofenced environment. In some embodiments, a step is a single instance of foot movement during walking or running, and counted by detecting the motion of the user's body, often through the use of sensors such as accelerometers, gyroscopes, or pedometers embedded in wearable devices or mobile equipment. Each step involves the transfer of weight from one foot to the other, creating a rhythmic pattern that can be tracked and quantified. The length of a step, known as the stride length, varies from person to person and can be influenced by factors such as height, speed, and terrain. In some embodiments, the stride length is predetermined. Methods of determining the number of steps on the traveled path 816 is discussed with reference to FIG. 10.

Notification 818 is an alert generated by the system based on the data collected from device 804 and the geofenced environment. The alert is displayed on device 804 or sent to a supervisor's device. The system generates various types of notifications 818, including visual alerts, audio signals, and haptic feedback via device 804. In some embodiments, notification 818 is customized based on the user's role, and/or experience level. For example, if a user spends an amount of time in a particular worksite exceeding a predefined threshold, the system generates a notification highlighting the achieved experience, which may be subsequently used for generating the user profile discussed with reference to user profile 902 in FIG. 9. This notification displays, for example, the specific tasks performed, the duration of time spent in particular worksites, and/or the number of steps performed, and provides a record of the user's experience in the worksite. In some embodiments, the notification 818 is generated and displayed when a user achieves a new professional milestone (e.g., experience level, professional position, pay scale change).

In some embodiments, notification 818 alerts user 802 when they enter a high-risk area defined by first geofence 806 or when they exceed and/or fail to satisfy a predefined threshold for time spent in a geofenced environment. The notification helps in ensuring that user 802 adheres to safety protocols within the worksite. For example, if user 802 enters a high-risk area such as a chemical storage zone within the first geofence 806, the system generates a notification 818 to alert the user. The notification ensures that user 802 is aware of the potential hazards and takes precautions, such as wearing appropriate protective equipment or following specific safety protocols. Conversely, if user 802 exceeds a maximum allowed time in a geofenced environment, the notification 818 ensures that user 802 does not overexert themselves or spend too much time in potentially hazardous areas. The notification 818 serves, in some embodiments, as a reminder to take breaks, rotate tasks, or follow safety guidelines.

In some embodiments, the notification 818 monitors and manages productivity. If user 802 is required to spend a minimum amount of time in a geofenced environment, the system tracks the time spent by the user in that zone. If user 802 fails to meet the predefined threshold for time spent, the system generates a notification 818 to alert the user or their supervisor. The alert helps in identifying potential issues such as inefficiencies, distractions, or the need for additional training. In some embodiments, the notification 818 assists in task management and coordination. For example, if user 802 completes a task in a geofenced environment and needs to move to the next task in a different geofenced environment, the system generates a notification 818 to guide the user.

FIG. 9 is a block diagram illustrating a generated user profile 902 displaying the monitored user activity, in accordance with one or more embodiments. User profile 902 includes user identification information 904, environment information (e.g., environment A information 906a, environment B information 906b), experience information (e.g., experience information 908a, experience information 908b), level information (e.g., level information 910a, level information 910b), pay scale 912, and so forth. Embodiments of generated user profile 902 can include different and/or additional components or can be connected in different ways.

User identification information 904 refers to the unique identifiers associated with the user being monitored. User identification information 904 includes the user's name, employee ID, contact details, and/or other personal data. In some embodiments, user identification information 904 includes biometric data such as fingerprints or facial recognition data to ensure accurate identification and authentication of the user within the system. For example, the system uses facial recognition to automatically log the user into the device 804 when they enter the geofenced environment, ensuring that activity data is accurately attributed to the correct user if, for example, the device 804 is not specific to a user. The system matches the captured biometric data with the stored user identification information.

Environment information, such as environment A information 906a and environment B information 906b, refers to the specific geofenced areas where the user operates. Each environment is defined by geospatial data and includes details about the geographic boundaries, hazards, and tasks associated with that area. For example, environment A information 906a pertains to the smelting plant encompassed by the smaller geofence 808 in FIG. 8, while environment B information 906b pertains to the overall worksite encompassed by larger geofence 806 in FIG. 8. The system uses this information to track the user's activity within each environment and update the user profile accordingly. In some embodiments, environment information includes real-time environmental conditions such as temperature, humidity, and air quality.

Experience information, such as experience information 908a and experience information 908b, refers to the user's history and proficiency within specific environments. Experience information includes the duration of time the user has spent in each environment, the tasks performed, and/or any certifications or training completed. In some embodiments, experience information 908a includes detailed records of the user's performance in environment A, while experience information 908b includes similar records for environment B. For example, the system tracks the number of steps the user has operated specific machinery in environment A and updates the experience information to reflect their growing proficiency. A user’s history refers to a log of the user's past activities, tasks, and roles within various geofenced areas. For example, the history includes the specific projects the user has worked on, the duration of time spent in different zones, and/or the types of equipment or machinery operated.

Level information, such as level information 910a and level information 910b, refers to the user's skill level or rank within each environment. Level information is based on the user's experience, performance metrics, and any evaluations conducted by supervisors. Level information ranges, in some embodiments, from novice to expert and are determined by factors such as the duration of time spent in specific zones, the complexity of tasks performed, and/or the user's performance metrics. For example, level information 910a indicates that the user is a senior technician in environment A, while level information 910b indicates that the user is a junior technician in environment B. The system, in some embodiments, uses this information to assign tasks and responsibilities that match the user's skill level.

In some embodiments, experience information 908 and/or level information 910 depend on the user's activities within the geofenced environment. For example, a user who has spent significant time and completed numerous tasks within a smaller nested geofenced environment is classified as having a certain experience/level. Conversely, a user who has demonstrated proficiency across multiple departments within the larger geofenced environment encompassing the smaller geofenced environment is classified at a higher experience level due to their broader expertise and versatility.

Pay scale 912 refers to the compensation structure associated with the user. Pay scale 912 includes the user's base salary, bonuses, and any other financial incentives. In some embodiments, pay scale 912 is dynamically adjusted based on the user's performance, experience, and level information. For example, a user who consistently performs well in high-risk environments receives a higher pay scale compared to a user with less experience or lower performance metrics.

In some embodiments, the user profile 902 includes one or more productivity metrics. Productivity metrics are quantifiable measures of the user's efficiency and effectiveness in performing tasks within the geofenced environment. Productivity metrics include the number of steps taken, tasks completed, time spent on specific activities, and/or output levels. For example, a productivity metric illustrates that a user consistently completes maintenance tasks 20% faster than the average time, indicating high efficiency.

Some embodiments can be understood with reference to FIG. 10. FIG. 10 is a flow diagram illustrating a process or method 1000 for monitoring user activity within a geofenced environment, in accordance with one or more embodiments. In some embodiments, the method 1000 is performed using computer system 900 illustrated and described in more detail with reference to FIG. 9. Likewise, other embodiments include different and/or additional steps, or are performed in a different order.

In step 1002, the system obtains, by a computing device, a set of geospatial data that defines a geofence around a geographic area. The geofence outlines a virtual perimeter or boundary of the geographic area. The system includes a set of portable devices (e.g., computing devices) wirelessly communicating with a host server, where each portable device is associated with a corresponding user. For example, each portable device of the set of portable devices is a smart radio enabled to communicate with other smart radios by transmitting and receiving broadcast signals. The system includes a communication interface of the host server communicatively connected to each of the set of portable devices, where the communication interface receives reporting data from one or more portable devices.

The set of geospatial data indicates a content of the geographic area bounded within the geofence. Examples of the content of the geographic area include the type of worksite, physical features, infrastructure, hazardous areas, operational zones, and/or environmental conditions. The type of worksite specifies whether the area is a construction site, manufacturing plant, warehouse, mining site, or any other type of worksite, and can further include specific characteristics and/or requirements directed to how the geofence is managed and monitored. Physical features include information about buildings, roads, open spaces, and other physical structures within the geofence, such as a factory floor with specific zones for different types of machinery, storage areas, and employee workstations. Infrastructure details include power lines, water supply systems, and communication networks (e.g., to ensure that user activities do not interfere with critical infrastructure and for planning maintenance tasks). Hazardous areas identify regions within the geofence that pose potential hazards, such as chemical storage zones, high-voltage areas, or regions with heavy machinery. Operational zones specify different operational zones within the worksite, such as assembly lines, loading docks, and quality control areas. Environmental conditions include real-time data on temperature, humidity, air quality, and noise levels within the geofence.

In some embodiments, the system dynamically adjusts the geographic area defined by the geofence based on predefined criteria. For example, the predefined criteria includes a time of day associated with the geographic area, the frequency or the magnitude of the presence of the user at the content of the geographic area, and/or environmental conditions associated with the geographic area. For example, if a maintenance task is scheduled in a particular section of the worksite not normally within the geofence, the geofence can be adjusted to include the section to monitor user activity during a particular scheduled time period to enable the system to track user activities during the maintenance task. Once the task is completed, the geofence is resized to the original boundaries.

In step 1004, the system detects, by one or more sensors of the computing device, a presence of a user within the geofence. In some embodiments, the user is associated with a user profile. For example, each user is associated with a user profile stored on the host server. The user profile indicates a frequency or a magnitude of the presence of the user at the content of the geographic area. In some embodiments, when a user enters the geofenced area, the computing device then cross-references the detected user with the stored user profiles on the host server. For example, the computing device matches the unique identifiers detected by the sensors with the identifiers stored in the user profiles. Once a match is found, the system updates the user profile with the new presence data, including the time of entry, duration of stay, and/or specific nested geofences visited within a larger geofence.

The user profile, in some embodiments, records a work history of the user. The work history includes, for example, the frequency or the magnitude of the presence of the user at a plurality of geographic areas. The historical data is used to analyze user activity patterns, track proficiency, and/or identify areas for improvement. For instance, if a user frequently visits a specific zone within the geofence and spends a significant amount of time there, the system infers that the user is proficient in tasks associated with that zone. Conversely, if a user rarely visits a particular area or spends less time there, it indicates a need for additional training or supervision.

In step 1006, the system calculates, by the one or more sensors the computing device, a number of steps traveled by the user within the geofence. The number of steps is calculated based on changes location and/or speed of the user within the geofence. For example, the communication interface of the host server receives reporting data that includes the number of steps of the user and/or the geospatial data of the user. In some embodiments, the system uses GPS data to track the user's position at regular intervals, such as every second or every few seconds. The GPS module in the user's device provides latitude, longitude, and altitude coordinates, which are timestamped and sent to the host server. The system determines the distance traveled by calculating the straight-line distance between consecutive GPS coordinates and summing the distances to obtain the total distance traveled within the geofence.

In some embodiments, the number of steps traveled by the user within the geofence is calculated based on one or more additional sensors of the computing device. The one or more additional sensors include, for example, a gyroscope, a global positioning system (GPS), and/or a pedometer. The gyroscope measures the orientation and angular velocity of the device, distinguishing between different types of activities, such as walking, running, or standing still. The pedometer counts the number of steps taken by detecting the repetitive motion of the user's body, such as through accelerometer data. The accelerometer measures the acceleration forces acting on the device, identifying the characteristic patterns of walking or running.

In some embodiments, the number of steps traveled by the user within the geofence is measured by determining, by the one or more sensors of the computing device, a distance traveled by the user within the geofence, and dividing a determined distance by a predetermined step length. The predetermined step length is based, in some embodiments, on the user's average stride length, which is customized for each user based on their height and walking pattern. The predetermined step length is stored, in some embodiments, locally or in a cloud-based server for subsequent retrieval during subsequent user activity within the geofenced environment.

In some embodiments, the system obtains, by the computing device, a plurality of sets of geospatial data that define a plurality of geofences, where a first geofence of the plurality of geofences is nested within a second geofence of the plurality of geofences. The system detects the presence of the user within the first geofence and the second geofence, and calculates, by the one or more sensors the computing device, the number of steps traveled by the user within the first geofence or the second geofence.

The system, in some embodiments, displays, on the computing device, a first visual representation of the geographic area defined by the geofence and a second visual representation of the number of steps traveled by the user within the geofence. The visual representations help supervisors and users to understand the spatial context of the worksite and the user's activity within the worksite. The first visual representation is, in some embodiments, a map or diagram that outlines the geographic area defined by the geofence. The map is displayed on the computing device, such as a tablet, smartphone, or computer screen, and includes various layers of information (e.g., locations of safety equipment, emergency exits, restricted areas) to provide a comprehensive view of the worksite. The second visual representation displays the number of steps traveled by the user within the geofence.

For example, a bar chart illustrates the number of steps taken by the user each hour throughout the day. Each bar represents a specific time interval, and the height of the bar corresponds to the number of steps taken during that interval. This allows supervisors to quickly identify periods of high or low activity and assess the user's productivity and engagement. Alternatively, a heat map is used in some embodiments to visualize the user's movement patterns within the geofence. The heat map displays the geographic area with color-coded regions that indicate the intensity of the user's activity. Areas where the user has taken many steps are shown in warmer colors, such as red or orange, while areas with fewer steps are shown in cooler colors, such as blue or green.

In step 1008, the system modifies (e.g., via a processing unit of the host server) the user profile, by the computing device, to increase the frequency or the magnitude of the presence of the user at the content of the geographic area indicated by the user profile in accordance with the number of steps. The user profile includes, in some embodiments, productivity metrics generated based on the number of steps traveled by the corresponding user at the content of the geographic area, task completion rates at the content of the geographic area, and/or output levels at the content of the geographic area.

In some embodiments, the system automatically generates, based on the user profile, a resume associated with the user. The resume includes a text, an image, an audio, and/or a video file. The text, the image, the audio, and/or the video file indicates the frequency or the magnitude of the presence of the user at the content of the geographic area. The resume is related to the experience and/or proficiency of the user in the content of the geographic area, and, in some embodiments, includes an indication of the content of the geographic area. For example, the resume quantifies user activity using the user profile, such as “Walked an average of 10,000 steps per day in the smelting plant,” which demonstrates high levels of activity and engagement across the plant.

In some embodiments, the system detects an increase in the number of steps traveled by the user within the geofence. Responsive to detecting the increase in the number of steps, the system dynamically updates the resume, by the computing device, to increase the frequency or the magnitude of the presence of the user indicated by the text, the image, the audio, or the video file of the resume. Furthermore, the system dynamically updates a user’s resume when certain thresholds are met or exceeded.

In some embodiments, the system classifies the user into an experience level of a set of experience levels corresponding to the content of the geographic area based on the number of steps within the geofence. The system updates the user profile in accordance with the experience level. If the number of steps satisfies a pre-defined threshold for a particular classification (e.g., to be classified as “Level 2” in operating in a plant, the user must average 10,000 steps per workday for a month), the resume is automatically updated accordingly. When the system detects that the user has consistently met or exceeded this threshold over a specified period, the system updates the resume to reflect this new classification. Similarly, the resume is dynamically updated to reflect a decline in activity (e.g., new classification or level based on decreased user activity in the geofence).

The geographic area is, in some embodiments, bounded within the geofence is a work environment. Based on the frequency or the magnitude of the presence of the user at the content of the work environment indicated by the user profile, the system matches the user with a service associated with the content of the work environment. For example, if the user frequently operates in a high-risk area such as a smelting furnace zone, the system identifies that the user requires specialized safety training or equipment. The system automatically matches the user with relevant safety training programs, personal protective equipment (PPE) suppliers, or health monitoring services to ensure the user's safety and compliance with workplace regulations.

In some embodiments, the system suggests new positions based on the user's proficiency and activity data. For example, if a user consistently demonstrates high proficiency and engagement in the smelting furnace area, the system suggests a promotion to a supervisory role within that zone. The system analyzes the user’s performance metrics, such as the number of steps taken, tasks completed, and time spent in particular areas, to identify the suitability for higher responsibilities.

In some embodiments, based on the number of steps traveled by the user within the geofence, the system generates, by the computing device, a notification configured to be displayed on the computing device in response to satisfying a predefined threshold within the geofence. For example, if a worker in a smelting plant consistently reaches a daily step count of 10,000 steps, the system triggers a notification to acknowledge this achievement. This notification might appear on the worker's mobile device or workstation screen, congratulating them for their high level of activity and engagement. Additionally, the notification provides actionable insights or recommendations, such as suggesting a short break to prevent fatigue or highlighting the completion of a milestone.

Modifying the user profile includes, in some embodiments, adjusting a pay scale associated with the user based on the number of steps traveled by the user within the geofence. For instance, in a smelting plant, the system tracks the number of steps a worker takes within the geofenced area and use this data to assess their activity level and engagement. If a worker consistently exceeds a predefined step threshold, indicating high productivity and dedication, the system automatically adjusts their pay scale to reflect this increased effort. This adjustment might involve a direct increase in hourly wages or the provision of performance-based bonuses. By linking compensation to measurable activity metrics, the system incentivizes workers to maintain high levels of engagement and productivity, ultimately contributing to a more efficient and motivated workforce.

In some embodiments, the system compares a first number of steps traveled by the first user within the geofence with a second number of steps traveled by a second user. The comparison allows for the evaluation of relative activity levels and engagement between different users within the same work environment. For example, in a smelting plant, the system tracks the steps of two workers to determine their respective levels of activity. If one worker consistently travels more steps than the other worker, the system identifies the worker as being more active and potentially more engaged in their tasks. The information is used for various purposes, such as performance evaluations, identifying candidates for promotions, and/or determining the need for additional training or support for less active users.

The system (e.g., via the host server) is enabled to, in some embodiments, adjust the geographic area based on historical number of steps traveled by the corresponding user at the content of the geographic area. For instance, in a smelting plant, the system evaluates historical step data to identify patterns in user movement and activity. If the data reveals that certain areas of the plant are frequently traversed by workers, the system dynamically adjusts the geofence boundaries to better encompass the smelting plant. The adjustment ensures that the geofenced area accurately reflects the actual work environment and user behavior.

In some embodiments, the system (e.g., via the host server) is enabled to aggregate the number of steps traveled by multiple users within the geofence. By summing the steps taken by the multiple users, the system identifies trends and patterns in workforce movement and engagement. For example, the system reveals that certain areas of the plant experience higher foot traffic during specific times of the day, indicating peak operational periods.

### Computing Platform

FIG. 11 is a block diagram illustrating an example computer system 1100, in accordance with one or more embodiments. In some embodiments, components of the example computer system 1100 are used to implement the software platforms described herein. At least some operations described herein can be implemented on the computer system 1100.

In some embodiments, the computer system 1100 includes one or more central processing units (“processors”) 1102, main memory 1106, non-volatile memory 1110, network adapters 1112 (e.g., network interface), video displays 1118, input/output devices 1120, control devices 1122 (e.g., keyboard and pointing devices), drive units 1124 including a storage medium 1126, and a signal generation device 1120 that are communicatively connected to a bus 1116. The bus 1116 is illustrated as an abstraction that represents one or more physical buses and/or point-to-point connections that are connected by appropriate bridges, adapters, or controllers. The bus 1116, therefore, includes a system bus, a peripheral component interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1194 bus (also referred to as “Firewire”).

In some embodiments, the computer system 1100 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 1100.

While the main memory 1106, non-volatile memory 1110, and storage medium 1126 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 1128. The term “machine-readable medium” and “storage medium” shall also be taken to include any medium that is capable of storing, encoding, or carrying a set of instructions for execution by the computer system 1100. In some embodiments, the non-volatile memory 1110 or the storage medium 1126 is a non-transitory, computer-readable storage medium storing computer instructions, which is executable by one or more “processors” 1102 to perform functions of the embodiments disclosed herein.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 1104, 1108, 1128) set at various times in various memory and storage devices in a computer device. When read and executed by one or more processors 1102, the instruction(s) cause the computer system 1100 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually affect the distribution.

Further examples of machine-readable storage media, machine-readable media, or computer-readable media include recordable-type media such as volatile and non-volatile memory devices 1110, floppy and other removable disks, hard disk drives, optical discs (e.g., compact disc read-only memory (CD-ROMS), digital versatile discs (DVDs)), and transmission-type media such as digital and analog communication links.

The network adapter 1112 enables the computer system 1100 to mediate data in a network 1114 with an entity that is external to the computer system 1100 through any communication protocol supported by the computer system 1100 and the external entity. The network adapter 1112 includes a network adapter card, a wireless network interface card, a router, an access point, a wireless router, a switch, a multilayer switch, a protocol converter, a gateway, a bridge, a bridge router, a hub, a digital media receiver, and/or a repeater.

In some embodiments, the network adapter 1112 includes a firewall that governs and/or manages permission to access proxy data in a computer network and tracks varying levels of trust between different machines and/or applications. The firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). In some embodiments, the firewall additionally manages and/or has access to an access control list that details permissions, including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

Consequently, alternative language and synonyms can be used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications can be implemented by those skilled in the art.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described but can be practiced with modification and alteration within the spirit and scope of the appended claims. Accordingly, the specification and drawings are to be regarded in an illustrative sense rather than a restrictive sense.

We claim:

1. A method comprising:
obtaining, by a computing device, a set of geospatial data that defines a geofence around a geographic area,
wherein the geofence outlines a virtual perimeter or boundary of the geographic area,
wherein the set of geospatial data indicates a content of the geographic area bounded within the geofence;
detecting, by one or more sensors of the computing device, a presence of a user within the geofence,
wherein the user is associated with a user profile,
wherein the user profile indicates a frequency or a magnitude of the presence of the user at the content of the geographic area;
calculating, by the one or more sensors the computing device, a number of steps traveled by the user within the geofence, wherein the number of steps is calculated based on changes in one or more of: location or speed of the user within the geofence; and
modifying the user profile, by the computing device, to increase the frequency or the magnitude of the presence of the user at the content of the geographic area indicated by the user profile in accordance with the number of steps.

2. The method of claim 1, wherein the number of steps traveled by the user within the geofence is measured by:
determining, by the one or more sensors of the computing device, a distance traveled by the user within the geofence; and
dividing a determined distance by a predetermined step length.

3. The method of claim 1, further comprising:
obtaining, by the computing device, a plurality of sets of geospatial data that define a plurality of geofences, wherein a first geofence of the plurality of geofences is nested within a second geofence of the plurality of geofences;
detecting the presence of the user within the first geofence and the second geofence; and
calculating, by the one or more sensors the computing device, the number of steps traveled by the user within the first geofence or the second geofence.

4. The method of claim 1, further comprising:
automatically generating, based on the user profile, a resume associated with the user,
wherein the resume includes at least one of: a text, an image, an audio, or a video file, and
wherein the text, the image, the audio, or the video file indicates the frequency or the magnitude of the presence of the user at the content of the geographic area.

5. The method of claim 4, further comprising:
detecting an increase in the number of steps traveled by the user within the geofence; and
responsive to detecting the increase in the number of steps, dynamically updating the resume, by the computing device, to increase the frequency or the magnitude of the presence of the user indicated by the text, the image, the audio, or the video file of the resume.

6. The method of claim 1, further comprising:
classifying the user into an experience level of a set of experience levels corresponding to the content of the geographic area based on the number of steps within the geofence; and
updating the user profile in accordance with the experience level.

7. The method of claim 1, wherein the geographic area bounded within the geofence is a work environment, further comprising:
based on the frequency or the magnitude of the presence of the user at the content of the work environment indicated by the user profile, matching the user with a service associated with the content of the work environment .

8. A method comprising:
obtaining, by a computing device, a set of geospatial data that defines a geofence around a geographic area,
wherein the geofence outlines a virtual perimeter or boundary of the geographic area, and
wherein the set of geospatial data indicates a content of the geographic area bounded within the geofence;
detecting, by one or more sensors of the computing device, a presence of a user within the geofence,
wherein the user is associated with a user profile, and
wherein the user profile indicates a frequency or a magnitude of the presence of the user at the content of the geographic area;
determining, by the one or more sensors of the computing device, a distance traveled by the user within the geofence, wherein the distance is calculated based on changes in one or more of: location or speed of the user within the geofence;
calculating, by the one or more sensors the computing device, based on the distance, a number of steps traveled by the user within the geofence;
modifying the user profile, by the computing device, to increase the frequency or the magnitude of the presence of the user at the content of the geographic area indicated by the user profile in accordance with the number of steps; and
generating a resume of the user based on the modified user profile,
wherein the resume includes the increased frequency or increased magnitude of the presence of the user at the content of the geographic area and an indication of the content of the geographic area, and
wherein the resume is related to one or more of: experience or proficiency of the user in the content of the geographic area.

9. The method of claim 8,
wherein the user profile is configured to record a work history of the user, and
wherein the work history includes the frequency or the magnitude of the presence of the user at a plurality of geographic areas.

10. The method of claim 8, further comprising:
dynamically adjusting the geographic area defined by the geofence based on predefined criteria, wherein the predefined criteria includes one or more of: time of day associated with the geographic area, the frequency or the magnitude of the presence of the user at the content of the geographic area, or environmental conditions associated with the geographic area.

11. The method of claim 8,
wherein the number of steps traveled by the user within the geofence is calculated based on one or more additional sensors of the computing device, and
wherein the one or more additional sensors include at least one of: a gyroscope, a global positioning system (GPS), or a pedometer.

12. The method of claim 8, further comprising:
based on the number of steps traveled by the user within the geofence, generating, by the computing device, a notification configured to be displayed on the computing device in response to satisfying a predefined threshold within the geofence.

13. The method of claim 8, wherein modifying the user profile further comprises adjusting a pay scale associated with the user based on the number of steps traveled by the user within the geofence.

14. The method of claim 8, further comprising:
displaying, on the computing device, a first visual representation of the geographic area defined by the geofence and a second visual representation of the number of steps traveled by the user within the geofence.

15. A system for managing user activity in a geofenced environment, comprising:
a set of portable devices configured to wirelessly communicate with a host server, wherein each portable device is associated with a corresponding user,
wherein each user is associated with a user profile stored on the host server, and
wherein the user profile indicates a frequency or a magnitude of a presence of the corresponding user at a content of a geographic area;
a communication interface of the host server communicatively connected to each of the set of portable devices, wherein the communication interface is configured to receive reporting data from one or more portable devices, wherein the reporting data includes, for each of the one or more portable devices:
a set of geospatial data that defines a geofence around the geographic area, wherein the geofence outlines a virtual perimeter or boundary of the geographic area, and wherein the set of geospatial data indicates the content of the geographic area bounded within the geofence, and
a number of steps traveled by the corresponding user within the geofence, wherein the number of steps is calculated based on changes in one or more of: location or speed of the corresponding user within the geofence; and
a processing unit of the host server configured to, in response to receiving the reporting data, modify the user profile to increase the frequency or the magnitude of the presence of the corresponding user at the content of the geographic area indicated by the user profile in accordance with the number of steps.

16. The system of claim 15, wherein the number of steps is a first number of steps, wherein the corresponding user is a first user, wherein the host server is further configured to:
compare the first number of steps traveled by the first user within the geofence with a second number of steps traveled by a second user.

17. The system of claim 15, wherein the user profile includes one or more productivity metrics generated based on at least one of: the number of steps traveled by the corresponding user at the content of the geographic area, task completion rates at the content of the geographic area, or output levels at the content of the geographic area.

18. The system of claim 15, wherein the host server is further configured to adjust the geographic area based on historical number of steps traveled by the corresponding user at the content of the geographic area.

19. The system of claim 15, wherein the host server is further configured to aggregate the number of steps traveled by multiple users within the geofence.

20. The system of claim 15, wherein each portable device of the set of portable devices is a smart radio configured to communicate with other smart radios by transmitting and receiving broadcast signals.
